(19) United States
(12) Patent Application Publication
(10) Pub. No.: US 2020/0003452 A1
(43) Pub. Date: Jan. 2, 2020

(54) HEATED UTILITY CONTAINER

(71) Applicant: Liam Kelly, Midland Park, NJ (US)

(72) Inventor: Liam Kelly, Midland Park, NJ (US)

(21) Appl. No.: 16/268,495

(22) Filed: Feb. 5, 2019

Related U.S. Application Data
(60) Provisional application No. 62/626,680, filed on Feb. 5, 2018.

(51) Int. Cl. F24H 1/00; B01L 7/00; B65D 25/02; F24H 1/22

(52) U.S. Cl. CPC F24H 1/0018; B01L 7/00; F24H 1/22; F24H 1/0072; B65D 25/02

(57) ABSTRACT

The invention is a heated container for carrying water and which permits water to be heated to a controlled temperature. The heated container has safety features to prevent burns and other damage from exposure to heated surfaces, while enabling one handling tools and working with the water from experiencing discomfort of working with cold water or overly hot water. Similarly a utility organizer and a brush holder are shown to demonstrate that the container may be used as a transport means for carrying tools and as means of keeping said tools at an ambient temperatures while in storage.

### CLAIM OF PRIORITY

This application claims prior of the U.S. Provisional Patent Application No. 62/626,680 filed on Feb. 5, 2018, the contents of which are fully incorporated herein by reference.

### FIELD OF THE INVENTION

The present invention relates to tools and accessories intended for those working under cold temperatures.

### BACKGROUND OF THE INVENTION

The present invention is described in the context of equine dentistry but may be used in any settings.

One working outdoors or away from running water, will need to carry a water pale around in order to clean and flush desired areas. Since standard pails lack the means of warming their contents, if heated water is desired, it must be obtained from the tap, or directly from a source of hot water. However, due to laws of nature and the fact that everything hot will eventually cool down, and rather quickly if exposed to cold or frigid surroundings, to preserve some warmth in an open pail, water that is obtained must at first be very hot.

This presents an especially difficult situation for veterinarians and veterinary oral technicians. Veterinary work is usually outdoors and in unheated facilities lacking running water, or heated running water. Yet their work requires ready and ample supply of water for flushing and cleaning. When obtaining heated water, care must be taken to verify that the water will not cause burns to the animal patient or the veterinary provisional. At the same time, the water must always be checked to confirm if the temperature level is sufficiently warm.

Even for heated pails, there is an additional problem that a veterinary professional need to insert his/her hands into such pail and place tools into the same pail. A heated pail requires the presence of scolding surfaces that when touched, will cause injury to flesh or materials. There must therefore be a way to heat the water without exposing tools and limbs to burn injuries, while at the same time providing a rugged device that for purposes of sound hygiene, is easily unassembled for cleaning.

### BRIEF DESCRIPTION OF THE DRAWINGS

FIG. 1 is an outside view of the heater attachment.

FIG. 2 is a cut-away diagram of the present invention.

FIGS. 3 & 4 show the inner cavity of the heated container.

FIGS. 5 & 6 demonstrated the inner circuitry and cover of the thermostat.

FIG. 7 is a detailed for of the heat guard.

FIGS. 8-11 demonstrate various utility inserts of the present invention.

### SUMMARY OF THE INVENTION

The device disclosed is a bucket containing a wall enclosing a cavity. The bottom edge of the wall forms a stand and the upper edge of the wall forms an opening into the cavity. The bottom edge of the wall encircles a bottom wall, which terminates the cavity at the bottom. An electrical controller placed on the exterior surface of the wall controls the temperature of a metal rod or coil that is inserted through the wall into the cavity. The electrical controller receives an electric current from an onboard power source, such as a battery, or a general electrical grid, which heats up the rod to a temperature controlled by an internal thermostat, which cuts off the power once the temperature is reached and reconnects the current once the rod cools off.

The cavity is divided between a section containing the metal rod or coil from a general cavity by a removable grate. The removal grate being supported on the surface of the bottom wall by a plurality of legs. The two sections are in communication with each other using a plurality of openings in the grate. The cavity is capable of receiving a quantity of liquids, preferably water, which is heated by the rod or coil. The heat is transferred throughout the quantity of water into both sections of the cavity.

The cavity is able to receive at least one insert. One such insert is in the form of two horizontal disks separated by and connected by at least two vertical tubes. Each disk is hollow in the middle. Thus when inserted into the bucket the tubes end up being oriented along the wall with the interior of the cavity being open. The disks may be semi-enclosed. The space unused by the disks may be utilized by different tools that are strapped along the top edge of the wall and immersed inside the cavity.

The purpose of the disclosed device is to create a means for a veterinary technician to transport tools that are immersed into a quantity of water. The water, and the tools due to this water, are heated to a certain desired temperature. The temperature controller is completely enclosed by a plate, which must be removed first to adjust the thermostat. This is a safety feature which prevents accidental increases in temperature of the water. The thermostat may be further limited to avoid exceeding temperatures of the water above what would be considered scalding to humans or animals, which may still be significantly below boiling point.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

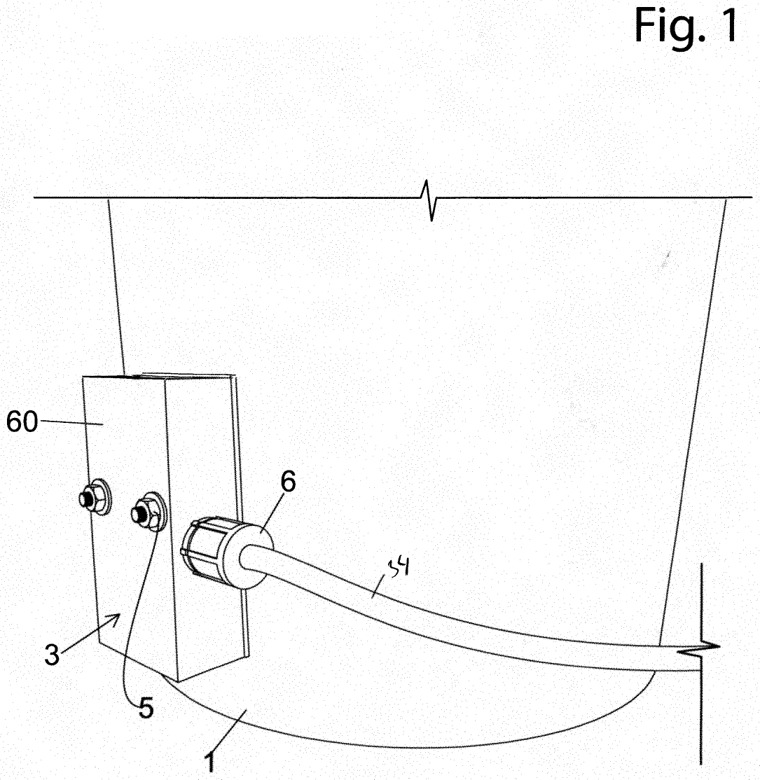

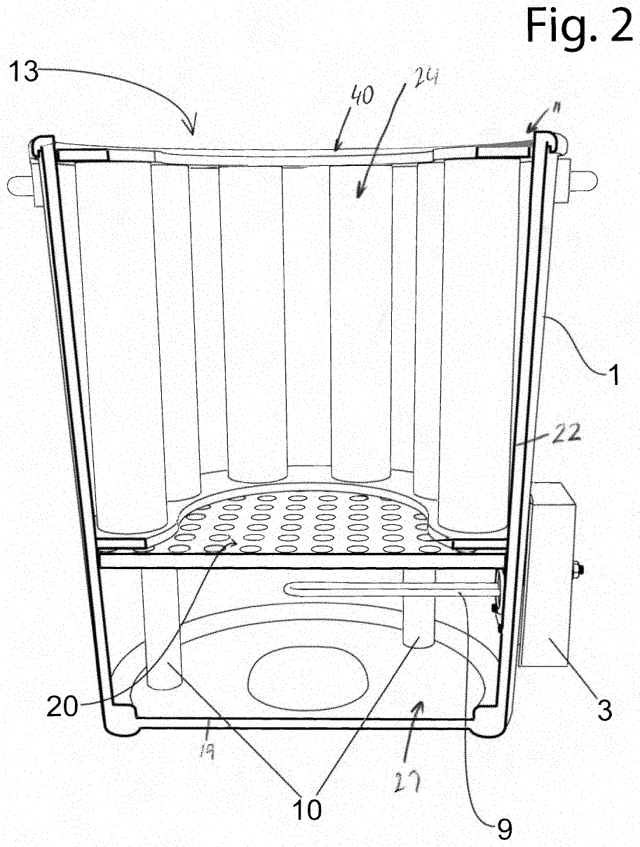

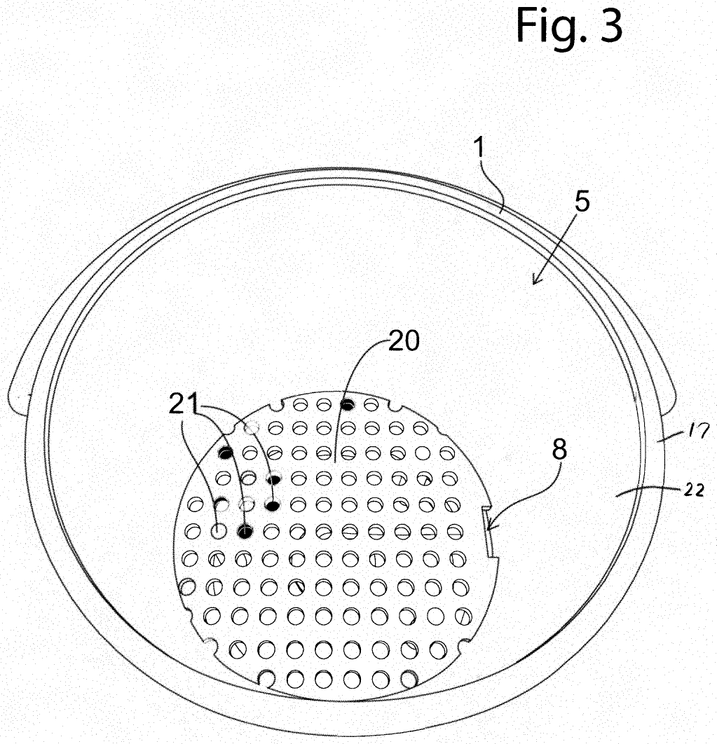

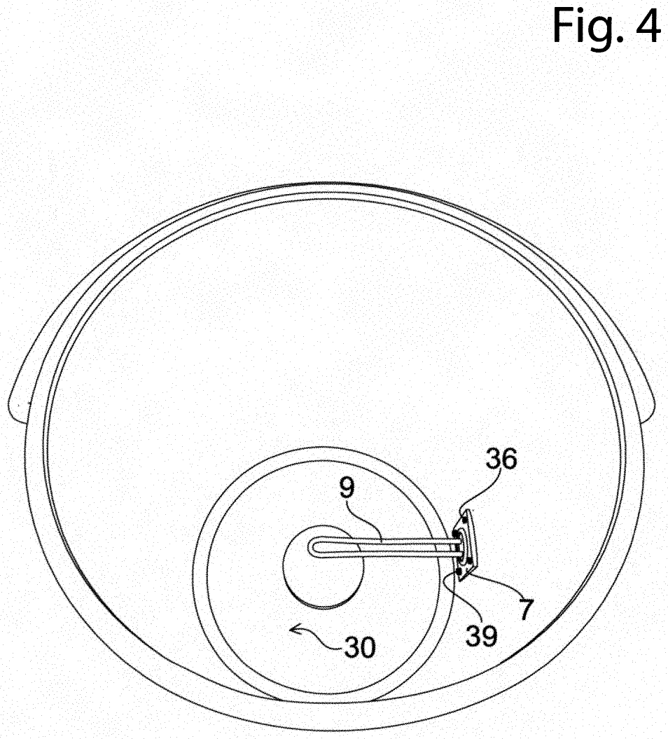

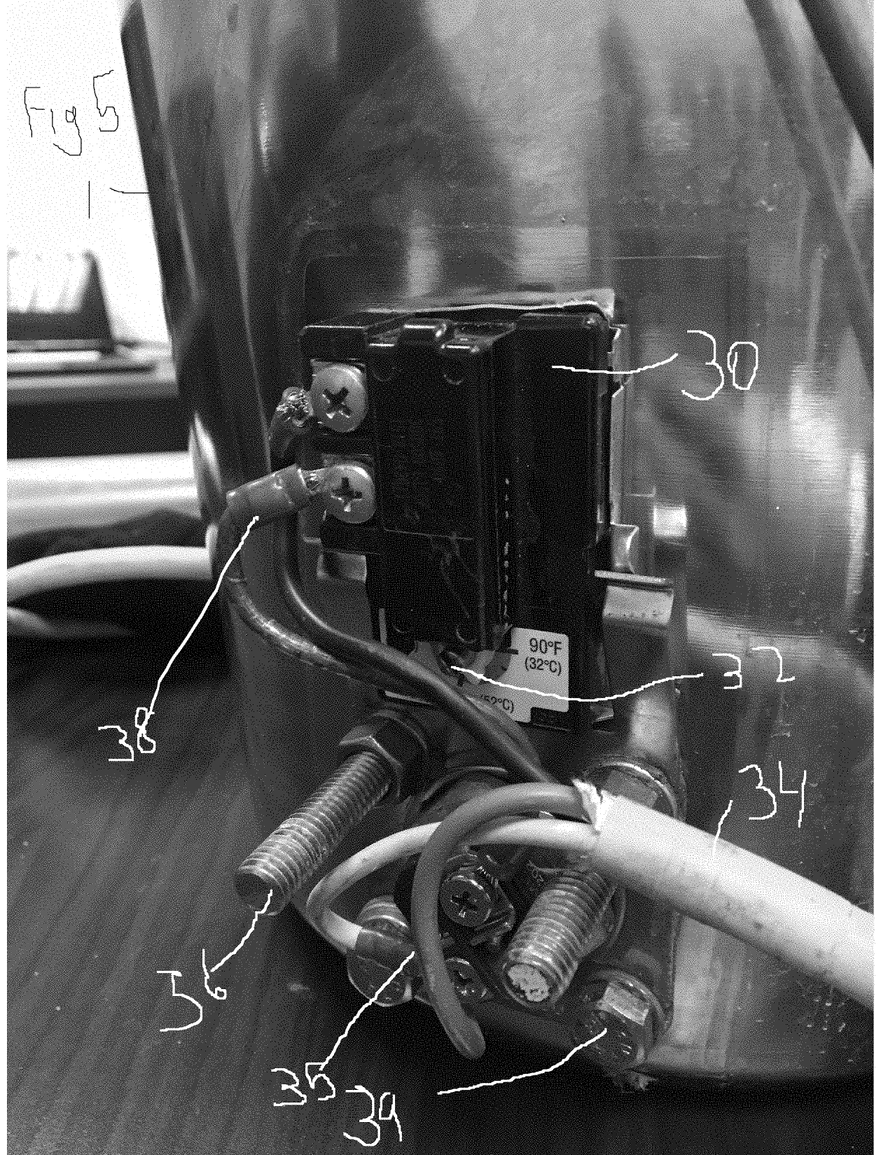

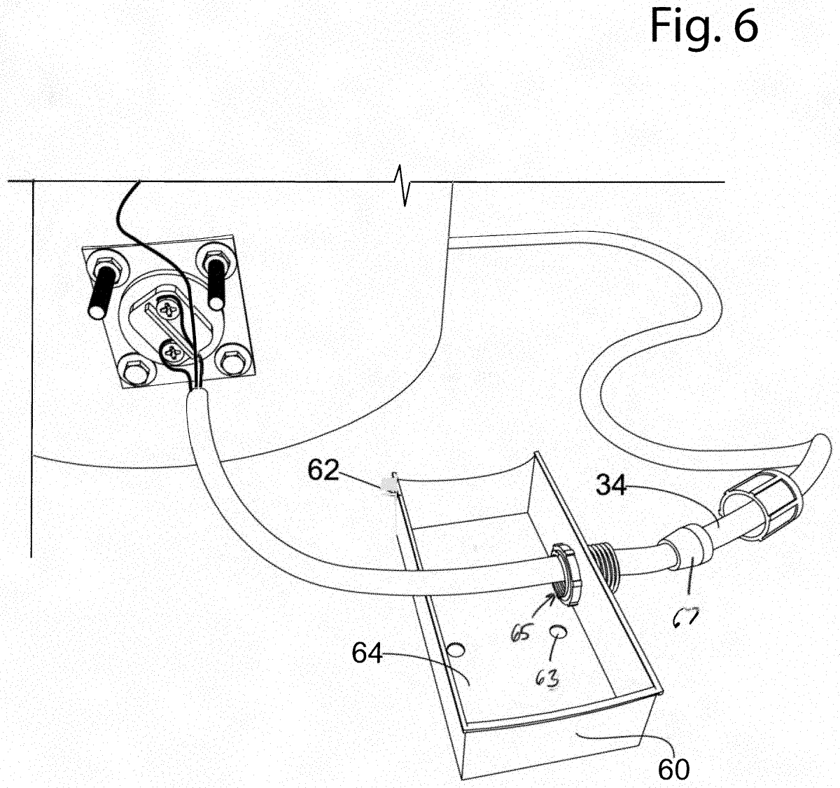

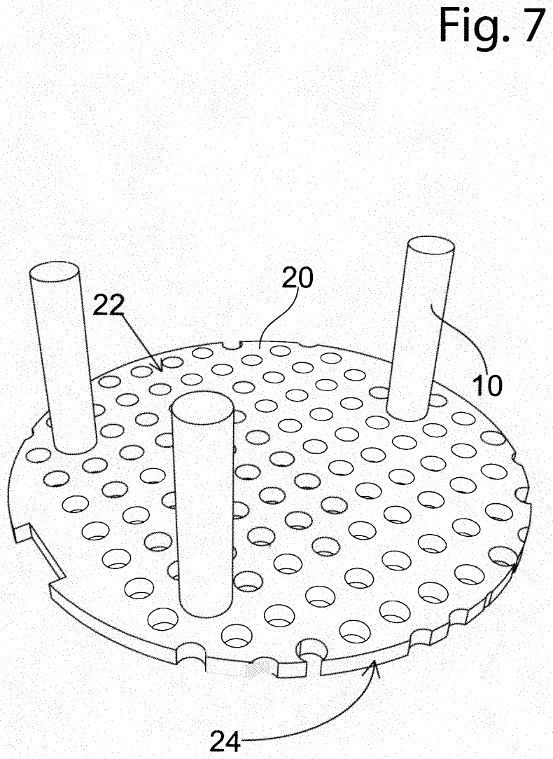

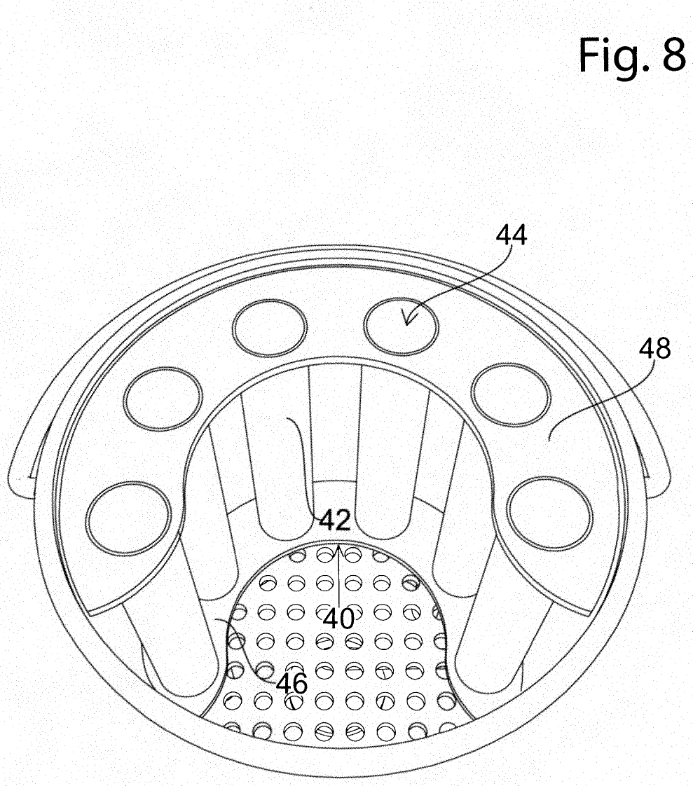

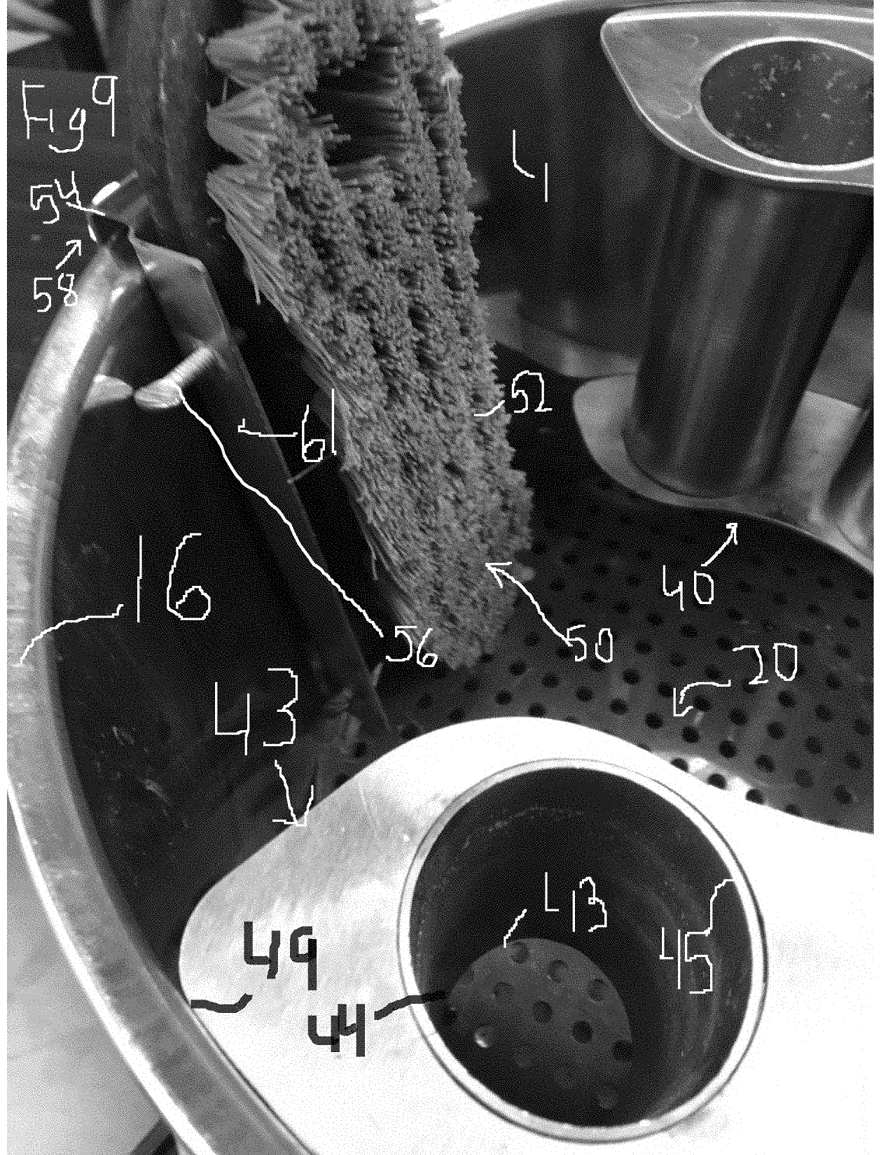

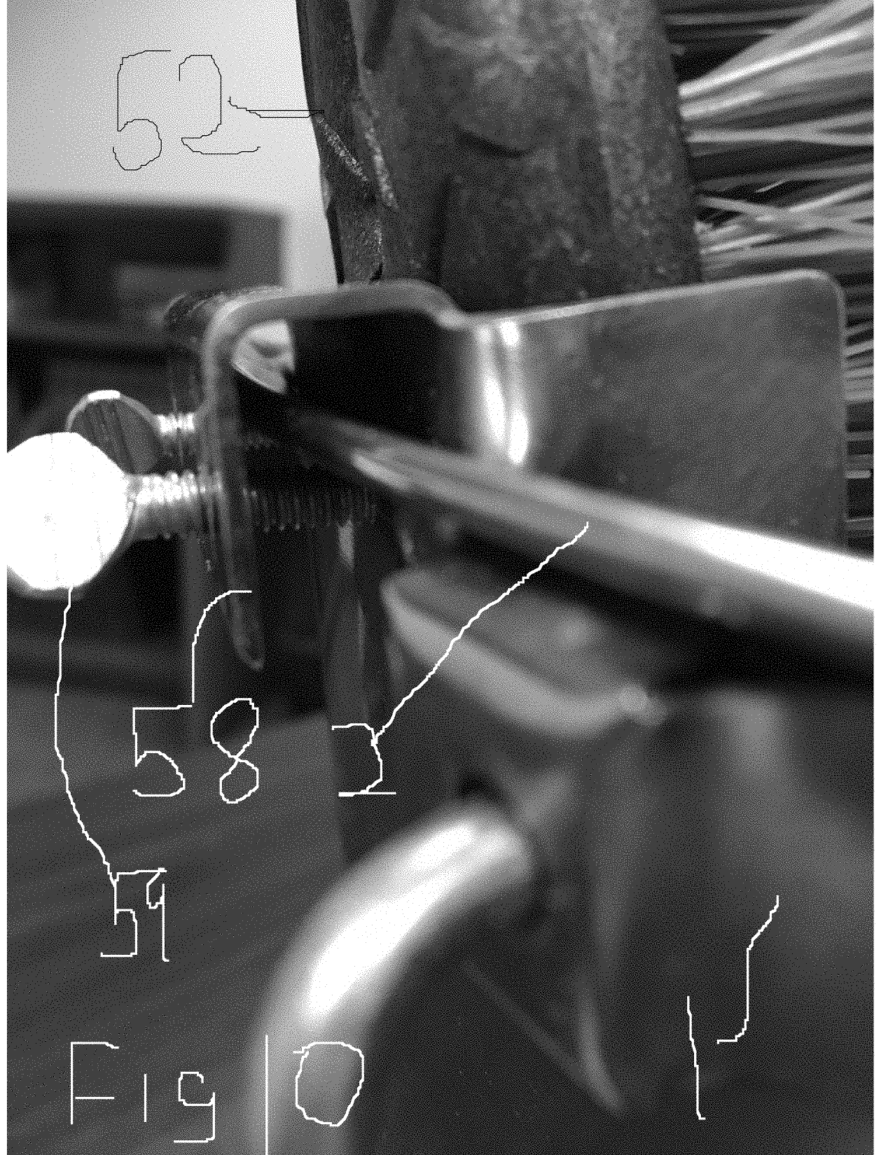

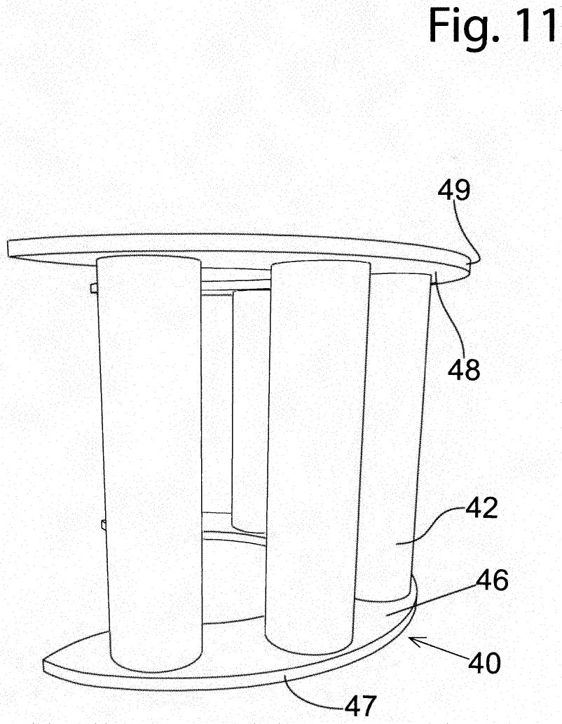

References below are made with respect to individual components identified in FIGS. 1-11. The specification describes the preferred embodiment of the present invention. However, various alternative expressions may be used to achieve the goal of the present invention.

The present invention is a heated utility container 1 that may be used to transport liquids, tools and a combination thereof. The heating apparatus 3 is encased in a protective cover 60, having a moisture protective insulation 62. A power cable 34 delivers electrical current to the terminals 35 of the thermostat 32 and terminals 38 of the switch 30. The electrical current may be provided using a AC or DC external power source or may be supplied from an onboard battery pack integrated with the heated utility container 1. The protective cover 60 shields the internal electrical components from the elements and moisture and protects the thermostat 32 from being accidently changed. The protective cover 60 is secured with fasteners 5 through the openings 63, which may be latches, fasteners or locks. The wire access point 65 is further insulated with a plug washer 67, which is tapered inward to be easily slide from the access point 65, so that the cover 60 may be removed.

As shown in FIG. 2 a wall 22 encloses a cavity 13 and has un upper edge 14 and a lower edge 17. The lower edge encloses a bottom wall 19. An insert or a utility organizer 40 contains at least two storage tubes 42 also known as utility containers. The cavity 13 is divided into two an upper section 24 and a lower section 27. In the lower section 27 the water is heated up using the heating element 9, which is a shown as a U-shaped rod, but may be shaped in a form of a coil. By convection the water in the upper section 24 is warmed as well due to openings 21.

The thermostat 32 controls the temperature of a heating element 9 by alternating the current flow to the switch 30, which in turn controls the on/off status of the heating element 9. The protective cap 60 that fits over the switch 30, services a dual purpose of protecting from moisture of the electrical circuitry enabling the heating element 9, and as a safety cap for the thermostat 32. The safety function is desired to prevent accidental or inadvertent temperature change, that may cause the liquid in the container 1 to rise without the veterinarian realizing that it has happened, potentially exposing the veterinarian as well as his/her animal patient to scalding water.

The inner cavity 13 of the container 1 is intended to carry tools of the trade, and liquids, as required. The heating element or coil 9 extends into the cavity 13 about one inch off the bottom surface 39 of the container 1. A heating plate 7 attaches to the sidewall 22 using fasteners 36. The heating plate 7 protects the thermostat 32 from seepage of liquids through the opening in the sidewall 22. The heating element 9 is then covered by a removable protective grate 20 which contains a plurality of openings 21. The openings 21 permit water circulation between the area around the heating element and the area above the grate 20, ensuring that all liquid in the container 1 is heated. The grate 21 is kept approximately two inches above the bottom surface 29 by a set of supports 10. A finger-hold 8 enables the grate 20 to be easily lifted out of the container 1.

The container 1 may be used for storage of liquids and as a transporter for tools. As a utility tool transport, the container 1 provides novel organizing inserts to maintain order and sort tools and equipment. Once such insert which may be used is the utility organizer 40, which is made of a lower plane or disk 46 and a parallel upper plane or disk 48, which are separated by a series of vertical storage containers 42. The tools are inserted into the cavity 44 and are retained by either the bottom plane 46, by the grate 20 or remain wedgedly suspended within the wall of the vertical storage container 42. The vertical storage container 42 may be cylindrical or square shaped or may be finished in a plurality of shapes for practical or aesthetic reasons. The utility organizer 40 may be made up of a mixture of different sized storage containers 42.

The utility organizer 40 is semicircular in size and conforms in shape with the perimeter of the container 1, with middle area unobstructed. Alternatively, the utility organizer may form a complete circle around the perimeter of the opening of the container 1. The diameter of the sidewall 22 of the container 1 gradually decreases toward the bottom surface 39. The utility organizer 40 is wedged into place close to the opening 13 of the container 1 by having an edge 47 of the lower plane 46 correspond to the diameter or bend of the container wall at that height. The upper edge 49 of plane 48 has a substantially larger arch that cannot be placed any lower than near the opening 13. Thus, the utility organizer 40 is dropped into the container through opening 13 and becomes lodged into place using its own weight, and not needing any fasteners.

The distance of the top plane 48 and bottom plane 46, when measured from one forward edge to the opposite forward edge 43, corresponds to greater than fifty percent of the circumference of the top lip 16 of the container 1. These dimensions help secure the utility organizer 40 from turning over within the opening 13. The edge 49 is flush with the top lip 16, creating sufficient friction from preventing the utility organizer 40 from spinning axially within the opening 13.

The container 1 may be used to store many other useful and practical tools. In another example of such an accessory is a brush caddy 54, holding a brush 50. The caddy 54 is mounted onto the lip 16 with a hook 58. The hook 58 may be secured with at least one press screw 59 or may be self-locking by creating a tight coupling with the top lip 16. The caddy 54 is contains sidewalls 61 that enclose the brush 52. The brush 52 is held in place within the sidewalls 61 with press screws 56. The caddy 54 is preferably sufficiently wide to accommodate most conventional brushes 52 of this type, the slight difference in dimensions among brushes is compensated through the use of the press screws 56. The caddy 54 enables the brush to be easily accessible and yet keeps the majority of the brush 52 submersed under heated water, thus increasing the appeal and comfort of the brush 52 both the veterinary professional and to his/her animal patient. Similarly, the storage containers 42 of the utility organizer 40 are preferably open at the bottom end 43 and the top end 45 for a free circulation of water that may be present within the container 1, to achieve a greater amount of flushing and to keep the tools from cooling off when not in use.

Although the disclosed device has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A heated container comprising: sidewall a bottom surface and a top opening; said sidewall enclosing a cavity; said sidewall tapering outwardly above said bottom surface at a gradual angle; an electrical switch connected to a power source; said electrical switch controlling an on/off status of a heating element; said heating element extending into a cavity created by said sidewall; a thermostat connected to said switch, said thermostat controlling said switch; removable grate, said removable grate suspended over said heating element; wherein said removable grate dividing said cavity into an upper cavity and a lower cavity; and wherein said removable grate having a plurality of opening to allow a free passage of liquid between said upper cavity and said lower cavity.

2. The heated container of claim 1, wherein said switch and said thermostat are located along an exterior surface of said sidewall.

3. The heated container of claim 2, further comprising a protective cap on top of said thermostat, said protective cap semi-permanently attached using at least one fastener.

4. The heated container of claim 1, wherein said removable grate is supported above said bottom surface with at least three legs.

5. The heated container of claim 1, further comprising a utility organizer, said utility organizer comprised of a bottom plane and a top plane, said top and said bottom planes joined together by at least two vertical containers, wherein an outer edge of said top plane overhangs an outer edge of said top plane such that said utility organizer may be wedged within said cavity due to an outward tapering of said sidewall.

6. The heated container of claim 5, wherein said at least two vertical container are of various sizes or shapes.

7. The heated container of claim 1, further comprising a caddy tool holder, said caddy tool holder removably fastened to a top edge of said sidewall.

8. The heated container of claim 7, wherein said caddy tool holder is of variable sizes.

9. In combination comprising a heated container and a utility organizer; wherein said heated container comprises a sidewall having a bottom edge and a top edge; said bottom edge enclosing a bottom surface and said top edge enclosing a top opening; said sidewall enclosing a cavity, said cavity accessing through said top opening; said sidewall tapering outwardly above said bottom surface at a gradual angle; an electrical switch connected to a power source; said electrical switch controlling an on/off status of a heating element; said heating element extending into a cavity created by said sidewall; a thermostat connected to said switch, said thermostat controlling said switch; and wherein said utility organizer comprised of a bottom plane and a top plane, said top and said bottom planes joined together by at least two vertical containers, wherein an outer edge of said top plane overhangs an outer edge of said top plane such that said utility organizer may be wedged within said cavity due to an outward tapering of said sidewall.

10. The combination of claim 9, further comprising a removable grate, said removable grate suspended over said heating element; wherein said removable grate dividing said cavity into an upper cavity and a lower cavity; said removable grate having a plurality of opening to allow a free passage of liquid between said upper cavity and said lower cavity.

11. The combination of claim 9, further comprising a caddy tool holder, said caddy tool holder removably fastened to a top edge of said sidewall.
